(19) United States
(12) Patent Application Publication
(10) Pub. No.: US 2011/0109077 A1
(43) Pub. Date: May 12, 2011

(54) Sketching Device for Copy Paper

(76) Inventors: Charles Haberstroh, San Diego, CA (US); Martin P. Haberstroh, San Diego, CA (US)

(21) Appl. No.: 12/760,852

(22) Filed: Apr. 15, 2010

Related U.S. Application Data
(60) Provisional application No. 61/259,602, filed on Nov. 9, 2009.

(51) Int. Cl. B42D 15/00

(52) U.S. Cl. 283/67; 283/45

(57) ABSTRACT

Apparatus and methods for facilitating writing on copy paper are presented. A sketching device can be inserted between upper and lower sets of copy paper to facilitate writing or sketching on the upper set while acting as a barrier to prevent undesired imprinting of the writing or sketching on the lower set. Preferred sketching devices include a physical pen guide that acts as a tactile guide for a drawing instrument. The sketching device can be included for use with a form having a grid, and can itself include a preprinted surface having character designations that indicate different types of information on x and y axes.

This application claims the benefit of U.S. provisional application No. 61/259,602 filed on Nov. 9, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is sketching devices.

### BACKGROUND

Accurately drawing straight or curved lines traditionally requires the use of rulers, compasses, protractors, and/or other guides. U.S. Pat. No. 3,384,964 to Phillips describes an improved guide that has a plurality of valleys with rounded junctures. When Phillips' guide is placed beneath a paper sheet and a marking instrument is applied to the top surface of the paper sheet, the marking instrument follows the valleys in Phillips' guide to draw the desired line on the paper sheet.

It is also known to include a printed surface on such improved guides that reproduce graphing paper. In addition, U.S. Pat. No. 7,118,135 to Tims et al. discusses including printed lines on an improved guide to define a lined writing area. Both Phillips and Tims, however, lack any character designations that indicate different types of information on x and y axes that assist a user in filling out a form.

Thus, there is still a need for a sketching device for use in completing a form having a grid.

### SUMMARY OF THE INVENTION

The inventive subject matter provides apparatus, systems and methods in which a sketching device can be used to facilitate writing on a form having a grid. The sketching device can have a preprinted surface that includes character designations indicating different types of information on x and y axes of the grid. For example, the character designations could include instructions for a method of using the sketching device for a particular use. Such character designations can advantageously be used to assist a user in completing a form.

The sketching device can also have one or more physical pen guides, which are defined herein to mean a tactile guide for a pen, pencil, or other marking instruments. Physical pen guides include, for example, a pattern of raised bumps, a series of grooves, and combination(s) thereof. In contrast, a non-physical pen guide includes a line or other marking that a user could trace, but that is physically unable to guide a pen or other writing instrument.

Preferably, the raised bumps are sized and positioned to form a plurality of intersecting valleys, which can serve as a guide for a marking instrument that is applied to one or more sheets overlaying the valleys. The series of valleys could be parallel to each other, or be disposed perpendicularly or any other angle(s) with respect to neighboring valleys. As the marking instrument is dragged over the surface of the sketching device, a tip of the marking instrument would naturally travel along the physical pen guide.

As used herein, the phrase “use[d] in completing a form” includes at least partially completing the form. As used herein, the term “pattern” is defined as an array of bumps positioned with some discernable regularity, whether simple or complex. The pattern of bumps need not be discerned visually, but may be discerned using tactile senses. Contemplated patterns include, for example, orthogonal grids, isometric or other angled grids, rays, circles, ovals, or any combination(s) thereof. Preferably, the patterns are discernible using at least one of Cartesian coordinates, Polar coordinates, and/or logarithmic coordinates.

Preferred sheets include copy paper, although any commercially-suitable paper could also be used. As used herein, the term “copy paper” means carbon copy paper, carbonless copy paper, and other commercially suitable pressure sensitive paper that can be used to make a copy or copies of an original while the original is being created, and without the use of electronics.

In some contemplated embodiments, the sketching device could be coupled to a tablet that has at least upper and lower sets of a copy paper. As used herein, the term “set” includes two or more pieces. In one aspect of the invention, the sketching device could comprise a divider sheet that is advantageously inserted between upper and lower sets of the copy paper such that any writing on the upper set is not imprinted on the lower set. Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. Each of the upper and lower sets could be at least partially composed of copy paper or other suitable pressure sensitive paper.

Contemplated divider sheets can preferably comprise the sketching device, or otherwise have a physical pen guide disposed on at least a portion of the divider sheet. Once the divider sheet is inserted beneath an upper set of copy paper, writing could be facilitated by the divider sheet, and applied to the upper set.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart illustrating an exemplary method of facilitating writing on copy paper.

FIG. 2 is a perspective view of a sketching device.

FIG. 3A is a perspective view of a tablet having a sketching device coupled to a flap.

FIG. 3B is a perspective view of a tablet having a sketching device as a flap.

FIG. 4 is a sectional view of the sketching device with a paper.

FIG. 5 is a perspective view of an alternate embodiment of a sketching device.

FIG. 6 is a perspective view of yet another alternate embodiment of a sketching device.

FIG. 7 is a sectional view of an embodiment of a tablet with a sketching device.

FIG. 8 is a perspective view of an embodiment of a cover including a tablet and a sketching device.

### DETAILED DESCRIPTION

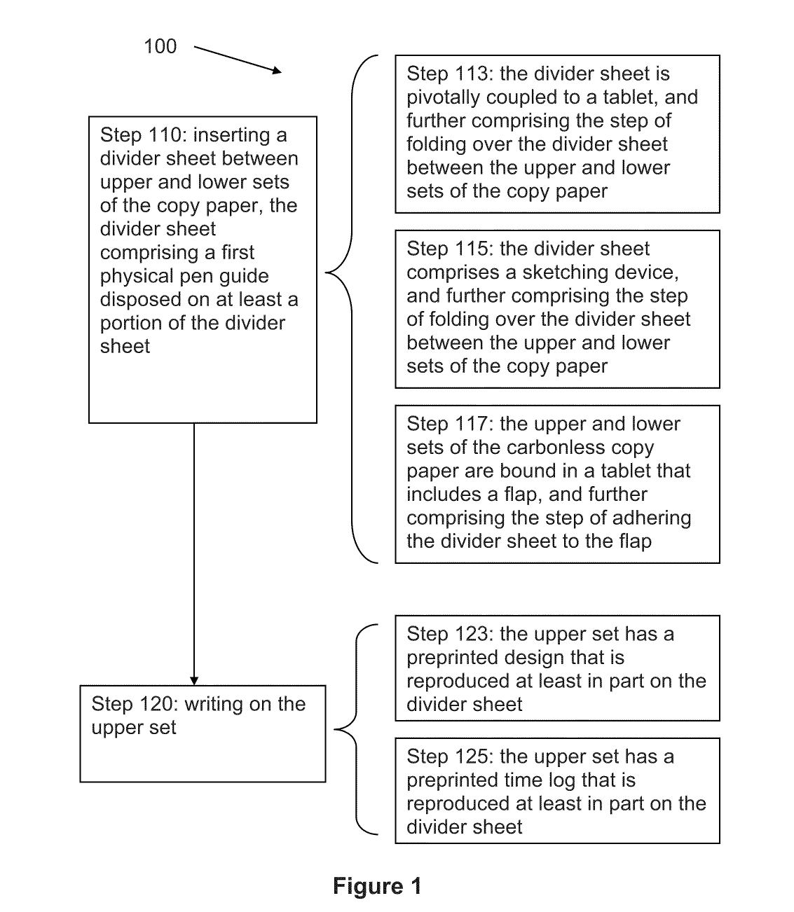

In FIG. 1, an exemplary method 100 of facilitating writing on copy paper is disclosed. Step 110 includes inserting a divider sheet between upper and lower sets of the copy paper. The divider sheet can have a physical pen guide covering at least a portion of the divider sheet. The physical pen guide can include, for example, a series of grooves, a pattern of raised bumps disposed on the divider sheet, and combinations thereof. The bumps can be sized and positioned to form a plurality of intersecting valleys between the bumps that define a tactile guide for a marking instrument. Although reference is made to a physical pen guide, it is contemplated that the physical pen guide can be configured to accommodate any commercially suitable marking instruments.

Preferred bumps can include raised portions that are at least partially rounded. It is also contemplated that some or all of the bumps can advantageously include apices that are approximately parallel to the surface of the divider sheet to reduce the likelihood of the bumps leaving an impression on the sheet. In further contemplated embodiments, the bumps can have pyramid-shaped portions such as those described in U.S. Pat. No. 4,451,519 to Irrgeher, or have other commercially suitable configurations.

The bumps can be fashioned in any commercially suitable manner(s) including, for example, embossing, molding, and/or any combinations thereof. Although preferred divider sheets include between 30-120 bumps per square inch, the number of bumps will vary based upon the desired pattern and marking instrument to be used.

In step 113, the divider sheet can be pivotally coupled to a tablet. The divider sheet can be inserted between a lower set of the copy paper and an upper set of the copy paper, and thereby facilitate writing or sketching on the upper set while acting as a barrier to prevent undesired imprinting of the writing or sketching on the lower set.

In step 115, a sketching device having at least one physical pen guide can comprise the divider sheet itself, which can then be folded over the lower set of the copy paper to rest between the upper and lower sets of the copy paper.

Alternatively, step 117 can include binding the upper and lower sets of paper in a tablet coupled to a flap, and adhering the divider sheet to the flap. However, it is also contemplated that the divider sheet could be coupled directly to the tablet. All commercially suitable fasteners are contemplated for adhering the divider sheet to the flap including for example, mechanical fasteners such as staples, stitches, clips, and snaps, glue or other adhesives, magnets, and any combination(s) thereof. For example, the divider sheet could be adhered to the flap by first removing a protective cover from an adhesive coupled to the divider sheet or flap, and then pressing the divider sheet against the flap.

In some contemplated embodiments, the divider sheet can be removably coupled to the tablet. Additionally or alternatively, the paper could be removably coupled to the tablet by any commercially suitable fastener(s) including, for example, adhesives, clips, snaps, rings, bindings, and any combination(s) thereof.

Step 120 can include writing on the upper set of copy paper above the divider sheet. Preferably, a marking instrument is applied to the copy paper to rest in a portion of the physical pen guide. For example, the marking instrument could rest in a valley between bumps on the divider sheet, and the marking instrument is dragged across the paper through valleys between the bumps such as to form characters, or elements of a drawing.

In step 123, the upper set of copy paper could have a preprinted design that is reproduced at least in part on the divider sheet. In step 125, the upper set of copy paper can have a preprinted time log that is reproduced at least in part on the divider sheet. By preprinting designs on the divider sheet itself, the divider sheet can serve as an exemplary template for a user of the sketching device. It is contemplated that the tablet can have multiple flaps or divider sheets with different patterns of valleys or grooves, or different patterns of preprinted design templates.

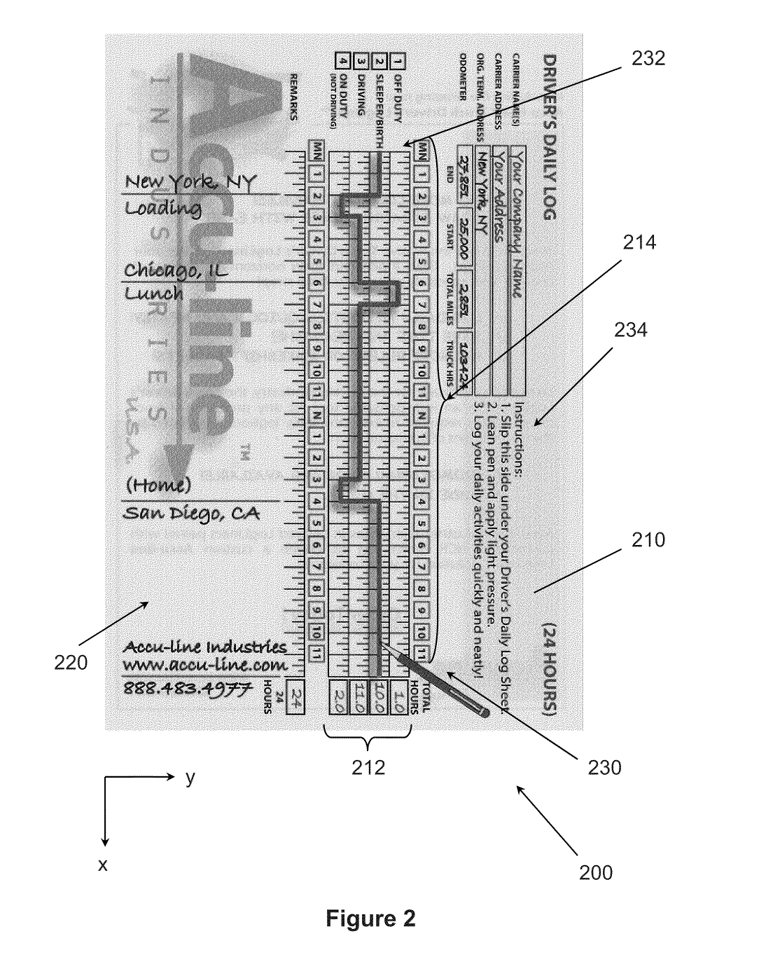

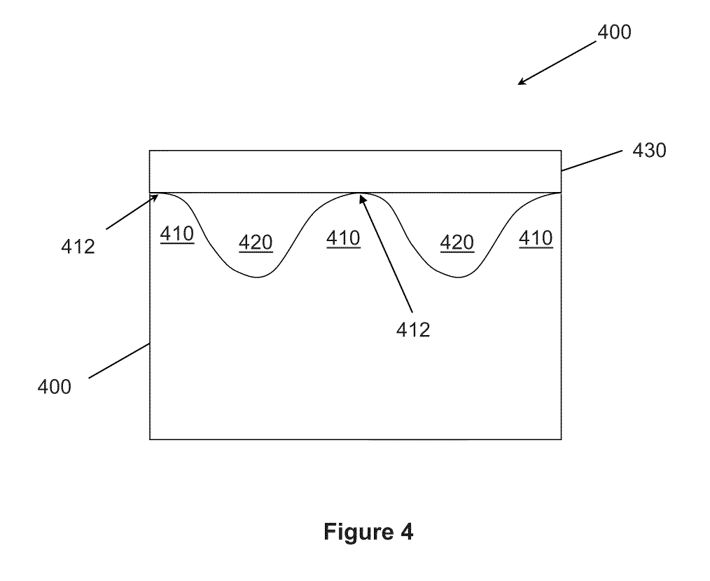

In FIG. 2, an embodiment of a sketching device 200 is illustrated that can be used to complete a form having a grid pattern. The sketching device 200 can have a preprinted surface 210 that includes character designations 212 and 214, each of which indicates a different type of information on respective x and y axes. Alternatively, the sketching device 200 could lack any preprinted surface, and in some contemplated embodiments, could be translucent or transparent. Alternatively or additionally, the sketching device 200 can have a physical pen guide 220 that includes a pattern of raised bumps disposed on the preprinted surface 210, which are sized and positioned to form a plurality of intersecting valleys as shown in FIG. 4.

Although patterns of raised bumps having variable width valleys are contemplated, preferred patterns include a plurality of evenly-spaced valleys resulting from a plurality of evenly-spaced bumps, each having the same size and dimension. The valley width can vary along the height of the bumps. Preferred valley widths have a maximum distance of between 0.1-1.0 mm, and more preferably 0.1-0.3 mm, to provide a valley sufficient in width to accommodate typically sized pens and pencils. However, contemplated valley widths could be varied as needed to accommodate various sized and dimensioned marking instruments including, for example, pencils, pens, highlighters, and art supplies.

The character designations 212 and 214 can include different types of information, and preferably include category and time, respectively. Other designations representing different types of information could also be used including, for example, weight and time, and any other designations that does not include a distance measurement.

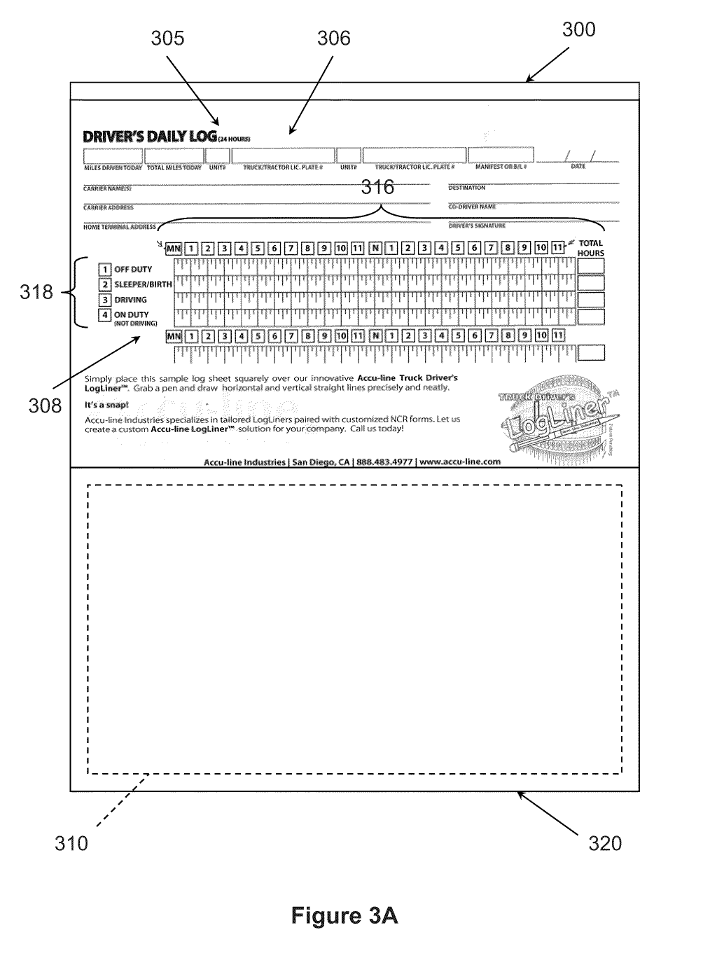

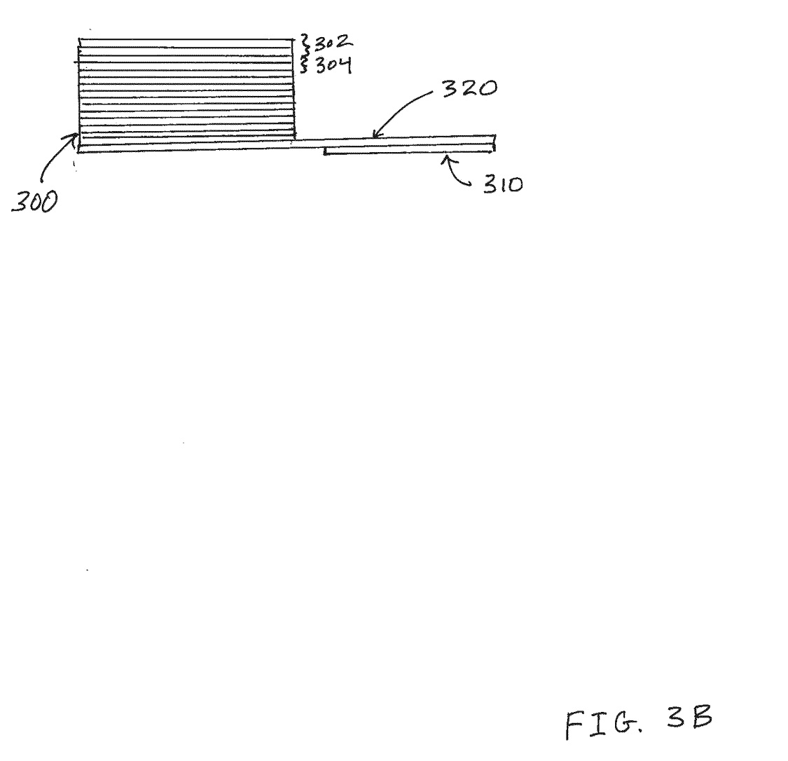

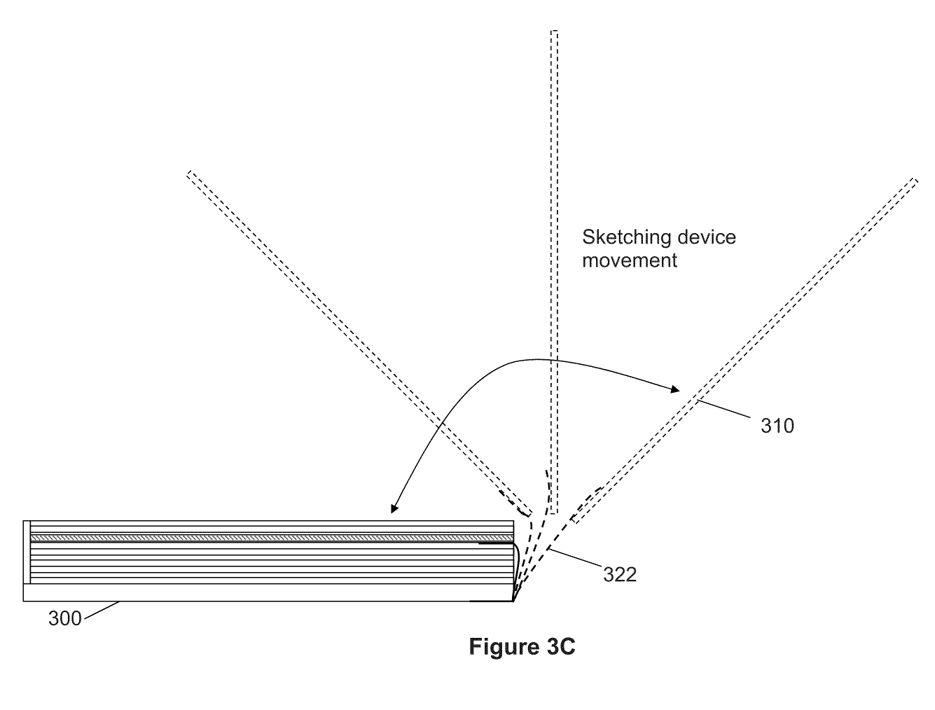

The preprinted surface 210 can advantageously include at least a portion of a driving log 230 or other form such that the sketching device 210 can assist a user in completing the driving log 230 or other form such as that shown in FIGS. 3A and 3B. In some embodiments, the portion of the driving log 230 can include at least a grid 232. For example, the sketching device 210 could be used to assist a user in tracing straight lines on a grid of a driving log shown in FIG. 3 to indicate how the user occupied each hour of a day.

In other embodiments, the portion of the driving log 230 can include instructions 234 that guide a user in filling out a driving log or other form shown in FIG. 3.

The sketching device 200 can be composed of any commercially suitable material(s) including, for example, cardboard, card stock, and other fibrous materials, plastics, plastic composites, and other polycarbonates, metals and metal composites, and any combination(s) thereof.

Alternatively, the sketching device 200 could be used in various other applications including, for example, copy paper to sketch floor plans of buildings such as for exterminators, or any other application that require duplicate sheets of a writing or drawing be created.

In FIGS. 3A-3C, a tablet 300 is shown that has an upper set 302 and a lower set 304 of copy paper. As used herein, the term “tablet” includes any bound collection of two or more sets of paper, which preferably has a backing. Contemplated tablets can be bound, or otherwise attached, using any commercially suitable fastener(s) including, for example, glue and other adhesives, spiral or other shaped combs, stitches, wires, rings, staples, snaps, clips, and other mechanical fasteners, and/or any combinations thereof. The fastener(s) can be chosen such that the paper and/or sketching device can be removably coupled to the tablet, if desired. For example, the tablet could comprise a three-ring binder or a clipboard. Such binding advantageously prevents the paper from being unintentionally separated from the tablet 300. Optionally, the tablet 300 could include a cover (not shown).

A sketching device 310 such as that shown in FIG. 1 can be coupled to a flap 320 of the tablet 300, such that the sketching device 310 can be used to assist a user in completing a form 306 having a grid 308. However, in other contemplated embodiments shown in FIG. 3C, the sketching device 310 can be the flap 320 coupled to the tablet 300 by a flexible binding 322. Other contemplated bindings can also be used including, for example, combs, tape, adhesives, cardboard or other paper-like materials, and combination(s) thereof. Preferably, the sketching device 310 is hinged or otherwise pivotally coupled to the tablet 300. This is advantageous as it limits the possibility of the sketching device 310 being lost or otherwise misplaced, while allowing the sketching device 310 to be used or stored as desired. Thus, for example, the sketching device 310 could be placed beneath the upper set 302, and then kept there or moved beneath a lower set for storage.

Each of the upper and lower sets 302 and 304, respectively, can have a preprinted design 305. A preprinted surface of the sketching device 310 preferably has at least a portion of the preprinted design 305 such that the preprinted surface can illustrate how to fill out the form 306. In preferred embodiments, the preprinted design 305 is a time log having a grid 308 that includes a time designator 316 and a category designator 318.

In some contemplated embodiments, the sketching device 310 can be translucent or transparent, and/or lack preprinted surface.

In other contemplated embodiments, the sketching device 310 and/or tablet 300 can include a paper guide to assist in properly aligning the copy paper with the sketching device. The sketching device and/or tablet can advantageously include an adhesive portion, clip or other commercially suitable fastener(s) such that undesired movement of the copy paper can be prevented.

FIG. 4 depicts the raised bumps 410 having apices 412 that are approximately parallel to the surface of the sketching device 400 to reduce the likelihood of the bumps 410 leaving an impression on the paper sheet 430. Valleys 420 are formed between adjacent bumps 410.

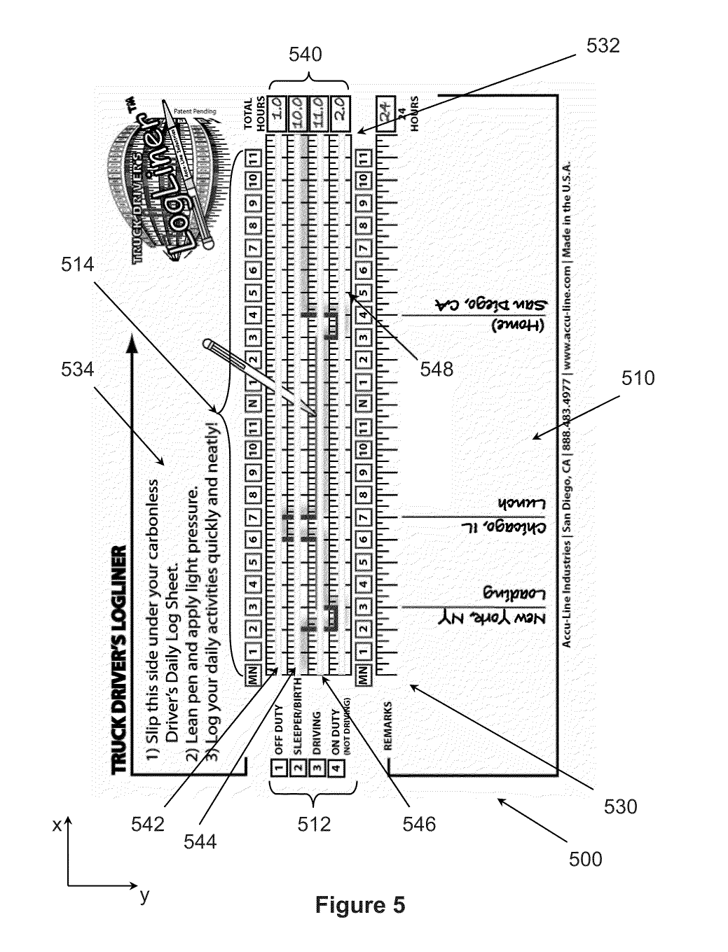

In FIG. 5, an alternative embodiment of a sketching device 510 is shown having a physical pen guide 540 that includes a series of grooves 542, 544, 546, and 548. Although the physical pen guide 540 is shown as a series of evenly-spaced parallel grooves, it is contemplated that the spacing between each groove could be varied, and/or that neighboring grooves could be non-parallel to adjacent grooves. In addition, at least some of the grooves 542, 544, 546, and 548 can be disposed at an angle (e.g., non-parallel) with respect to an edge of the sketching device 510. In currently preferred embodiments, the grooves 542, 544, 546, and 548 are formed by creating notches or other indentations in the sketching device 510. The grooves 542, 544, 546, and 548 could be a recessed portion of the sketching device 510 or a slot, for example. With respect to the remaining numerals in FIG. 5, the same considerations for like components with like numerals of FIG. 2 apply.

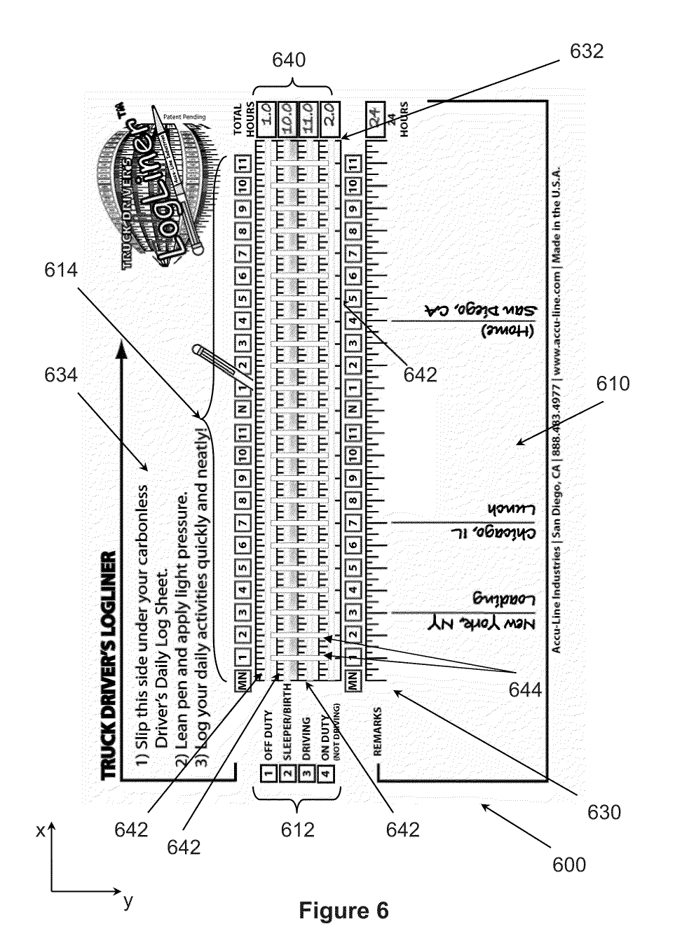

In some contemplated embodiments shown in FIG. 6, the physical pen guide 640 could comprise, a plurality of grooves 642 and 644, of which grooves 642 can be disposed to intersect with grooves 644. Although the grooves 642 and 644 preferably intersect at right angles, it is contemplated that at least some of the grooves 642 and 644 could intersect at non-right angles. With respect to the remaining numerals in FIG. 6, the same considerations for like components with like numerals of FIG. 2 apply.

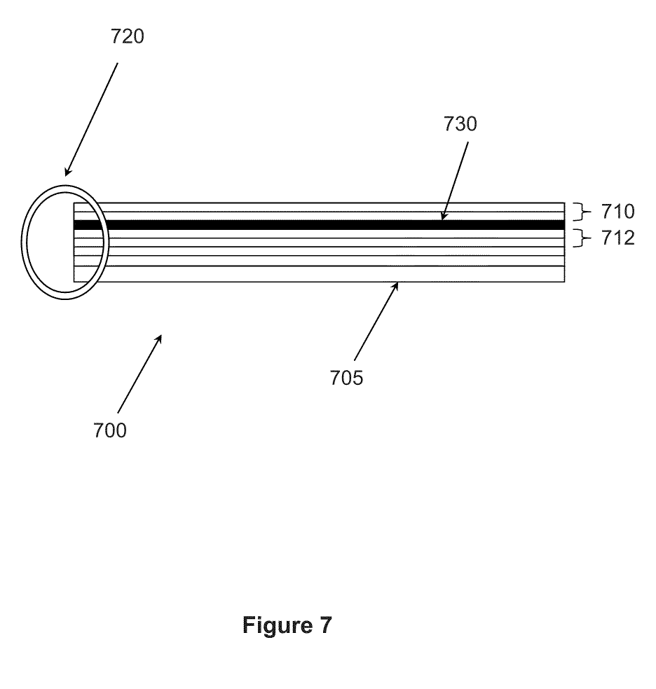

In FIG. 7, a tablet 700 is shown having at least first 710 and second sets 712 of copy paper. One or more rings 720 can be used to couple the first and second sets 710 and 712 to the tablet 700. The tablet 700 can also include a sketching device 730 that is coupled to the tablet 700, and preferably inserted between the first 710 and second sets 712 of the copy paper. The sketching device 730 can include one or more physical pen guides to guide a user in marking on the copy paper. Optionally, the tablet 700 can include a backing 705.

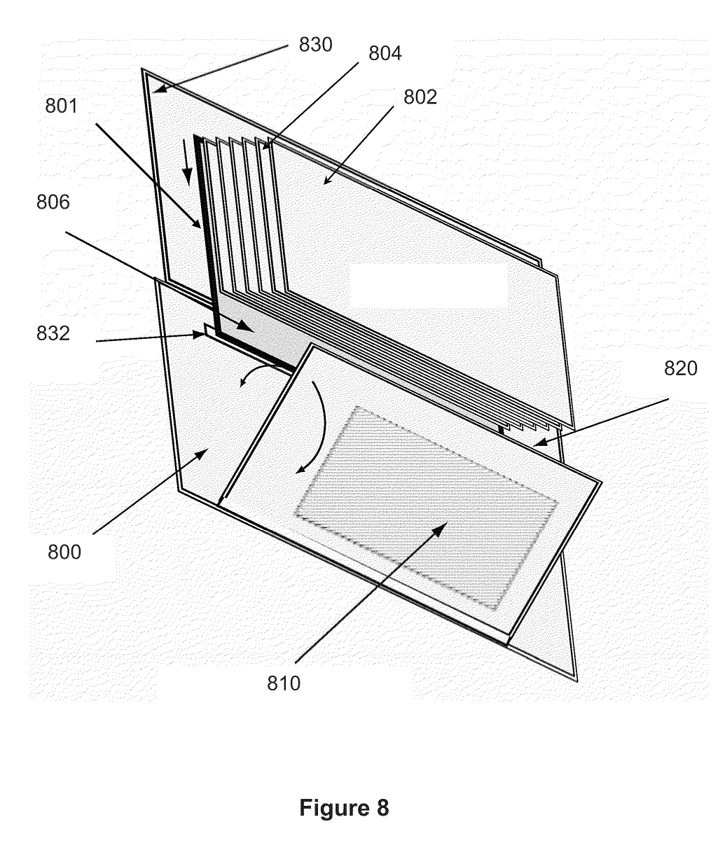

In FIG. 8, a tablet 801 having at least first 802 and second sets 804 of copy paper can be removably coupled to a cover 800. In some contemplated embodiments, a backing 806 of the tablet 801 can be inserted into a slot 832 or other aperture in an upper portion 830 of cover 800. In this manner, the tablet 801 can be held in place relative to the cover 800, and then be removed from the cover 800 when desired.

The cover 800 preferably includes a flap 820 that can be pivotally coupled to the cover 800. This is advantageous as it allows the flap 820 to be inserted between the first 802 and second sets 804 of copy paper, for example. Preferably, a sketching device 810 having at least one physical pen guide can be coupled to the flap 820. This advantageously allows the sketching device 810 to be utilized as a guide for a marking instrument when the flap 820 is inserted between sets of the copy paper.

The sketching device 810 can be coupled to the flap 820 by any commercially suitable fastener(s) including, for example, stitches, staples, clips, and other mechanical fasteners, glue and other adhesives, magnets, and any combination(s) thereof. Alternatively, it is also contemplated that the sketching device 810 could be directly coupled to the cover 800, without a need for a separate flap 820.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of facilitating writing on copy paper, comprising:
inserting a divider sheet between upper and lower sets of the copy paper, the divider sheet comprising a first physical pen guide disposed on at least a portion of the divider sheet; and
writing on the upper set.

2. The method of claim 1, wherein the first pen guide comprises a pattern of raised bumps that are sized and dimensioned to form a plurality of intersecting valleys.

3. The method of claim 1, wherein the first pen guide comprises a first series of grooves.

4. The method of claim 1, wherein the divider sheet further comprises a second pen guide comprising at least one of (a) a second pattern of raised bumps that are sized and dimensioned to form a plurality of intersecting valleys, and (b) a second series of grooves.

5. The method of claim 1, wherein the divider sheet is pivotally coupled to a tablet, and further comprising the step of folding over the divider sheet between the upper and lower sets of the copy paper.

6. The method of claim 1, wherein the divider sheet comprises a sketching device, and further comprising the step of folding over the divider sheet between the upper and lower sets of the copy paper.

7. The method of claim 1, wherein the upper and lower sets of the copy paper are bound in a tablet that includes a flap, and further comprising the step of adhering the divider sheet to the flap.

8. The method of claim 1, wherein the upper set has a preprinted design that is reproduced at least in part on the divider sheet.

9. The method of claim 1, wherein the upper set has a preprinted time log that is reproduced at least in part on the divider sheet.

10. A sketching device for use in completing a form having a grid, comprising:
a preprinted surface having character designations that indicate different types of information on x and y axes; and
a pattern of raised bumps disposed on the preprinted surface, and sized and positioned to form a plurality of intersecting valleys.

11. The sketching device of claim 10, wherein the different types of information are category and time.

12. The sketching device of claim 10, wherein the preprinted surface includes at least a portion of a driving log.

13. The sketching device of claim 12, wherein the portion comprises the grid.

14. The sketching device of claim 12, wherein the portion comprises instructions to fill out the driving log.

15. A tablet comprising the sketching device of claim 10, further comprising upper and lower sets of a copy paper.

16. The tablet of claim 15, wherein the sketching device is coupled to the tablet.

17. The tablet of claim 15, wherein the sketching device comprises a flap attached to the tablet.

18. The tablet of claim 15, wherein each of the upper and lower sets has a preprinted design, and wherein the preprinted surface has at least a portion of the preprinted design.

19. The tablet of claim 15, wherein each of the upper and lower sets has a preprinted time log, and wherein the preprinted surface has at least a portion of the preprinted time log.
